(19) United States
(12) Patent Application Publication
(10) Pub. No.: US 2026/0148644 A1
(43) Pub. Date: May 28, 2026

(54) SYSTEMS AND METHODS FOR PROVIDING TRAFFIC INFORMATION TO AN AIRCRAFT AT AN AIRPORT

(71) Applicant: THE BOEING COMPANY, Arlington, VA (US)

(72) Inventors: Umesh Hosamani, Bangalore (IN); Akshay Arun Sankeshwari, Bengaluru (IN)

(73) Assignee: THE BOEING COMPANY, Arlington, VA (US)

(21) Appl. No.: 18/956,621

(22) Filed: Nov. 22, 2024

(51) Int. Cl. G08G 5/06; B64D 47/06

(52) U.S. Cl. CPC G08G 5/51; B64D 47/06

(57) ABSTRACT

A system and a method include an aircraft including one or more lighting devices. A control unit is in communication with the one or more lighting devices. The control unit is configured to operate the one or more lighting devices to provide illuminated messages regarding traffic in relation to one or more ground paths at an airport on one or more surfaces.

### FIELD OF THE DISCLOSURE

Examples of the present disclosure generally relate to systems and methods for providing traffic information to an aircraft at an airport.

### BACKGROUND OF THE DISCLOSURE

Aircraft are used to transport passengers and cargo between various locations. Numerous aircraft depart from and arrive at a typical airport every day.

A “hot spot” at an airport is a location on an aerodrome movement area that may pose potential risk of collision or runway incursion, and where heightened attention by aircraft operators is necessary. As an example, a hot spot can be an intersection between two different taxiways or a taxiway and a runway, which poses a risk of potential incursions, due to a variety of causes, such as but not limited to airport layout, traffic flow, airport marking, signage and lighting, situational awareness, and/or training. Hot spots are depicted on airport diagrams as open circles or polygons with designations such as HS1, HS2, or the like.

As a pilot operates an aircraft during takeoff or landing, the pilot typically needs to pay attention to the areas surrounding the aircraft. As such, the pilot has to maintain eyesight in relation to the ground path (such as a taxiway, a runway, or the like) ahead of the aircraft. If, however, the pilot looks down at a map or a display showing hot sport designations, the pilot may lose situational awareness of the ground path and traffic proximate to the ground path.

### SUMMARY OF THE DISCLOSURE

A need exists for a system and a method for efficiently and effectively informing an operator of an aircraft of traffic information at an airport, such as at hot spots. Further, a need exists for a system and a method for providing traffic information to a pilot of an aircraft while ensuring that the pilot maintains situational awareness of a location of the aircraft.

With those needs in mind, certain examples of the present disclosure provide a system including an aircraft including one or more lighting devices. A control unit is in communication with the one or more lighting devices. The control unit is configured to operate the one or more lighting devices to provide illuminated messages regarding traffic in relation to one or more ground paths at an airport on one or more surfaces. The aircraft cam include the control unit.

In at least one example, the one or more lighting devices include one or more exterior lighting devices, and the one or more surfaces include a portion of the one or more ground paths ahead of the aircraft. As a further example, the one or more exterior lighting devices include one or more landing lights secured to one or more wings or a fuselage of the aircraft. In at least one other example, the one or more lighting devices include one or more interior lighting devices, and the one or more surfaces include an interior portion of a window within a flight deck or cockpit of the aircraft. In at least one other example, the one or more lighting devices include the one or more exterior lighting devices and the one or more interior lighting devices.

In at least one example, the control unit is configured to operate the one or more lighting devices responsive to one or more of tracking information received from a tracking sub-system, map information received from an airport database, or clearance information received from air traffic control. As a further example, the control unit is configured to operate the one or more lighting devices responsive to the tracking information received from the tracking sub-system, the map information received from the airport database, and the clearance information received from the air traffic control.

The illuminated messages can include one or more of symbols, shapes, colors, text, or graphics. As a further example, the illuminated messages include shapes colors, and text. In at least one example, the illuminated messages include readily discernable text and a readily discernable shape for a hot spot.

Certain examples of the present disclosure provide a method including operating, by the control unit, the one or more lighting devices to provide the illuminated messages regarding the traffic in relation to the one or more ground paths at the airport on the one or more surfaces.

### BRIEF DESCRIPTION OF THE DRAWINGS

FIG. 1 illustrates a block diagram of a system, according to an example of the present disclosure.

FIG. 2 illustrates a flow chart of a method, according to an example of the present disclosure.

FIG. 3 illustrates a schematic block diagram of a control unit, according to an example of the present disclosure.

FIG. 4 illustrates a perspective front view of an aircraft, according to an example of the present disclosure.

FIG. 5 illustrates a simplified diagram of an aircraft on a first ground path that intersects a second ground path at an airport, according to an example of the present disclosure.

FIG. 6 illustrates a simplified diagram of the aircraft on the first ground path that intersects the second ground path at the airport, according to an example of the present disclosure.

FIG. 7 illustrates a simplified diagram of the aircraft on the first ground path, according to an example of the present disclosure.

FIG. 8 illustrates a simplified diagram of the aircraft on the first ground path that intersects the second ground path at the airport, according to an example of the present disclosure.

FIG. 9 illustrates a simplified diagram of the aircraft on the first ground path that intersects the second ground path at the airport, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Ground movement hot spots are areas at an airport with a history or potential risk of collision or runway incursion, and where heightened attention by pilots, drivers and controllers is necessary. Ground movement hot spots can be depicted by a circle or an ellipse, although there is not currently a standard shape for depicting such areas.

Wrong surface hot spots are locations at an airport where an aircraft inadvertently attempts to depart or land on a wrong surface. Wrong surface hot sports can be depicted by an ellipse.

The United States Federal Aviation Administration (the “FAA”) has introduced arrival alert notices (“AAN”) at several airports with a history of misalignment risk. AANs provide a graphic which visually depicts an approach to a particular airport with a history of misalignment risk along with a description of such risk. AANs can incorporate standardized hot spot symbology. The FAA has standardized hot spot symbology to prevent pilot confusion regarding the meaning of or depiction of hot spots.

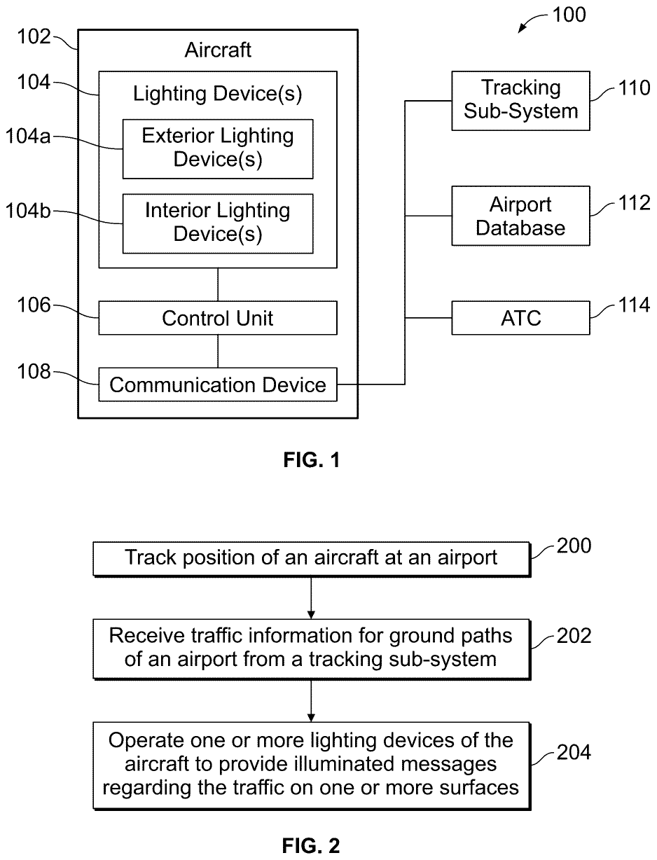

FIG. 1 illustrates a block diagram of a system 100, according to an example of the present disclosure. The system 100 includes an aircraft 102 including one or more lighting devices 104. The lighting devices 104 include one or both of exterior lighting devices 104a and/or interior lighting devices 104b. In at least one example, the lighting devices 104 include both the exterior lighting devices 104a and the interior lighting devices 104b.

As an example, the exterior lighting device(s) 104a include landing lights of the aircraft 102. Landing lights are positioned downward to illuminate ground paths at an airport. Examples of ground paths include runway(s), taxiway(s), airstrip(s), apron(s), parking area(s) at gate(s), and/or the like. The exterior lighting device(s) 104a are configured to illuminate a surface outside of the aircraft 102. For example, the exterior lighting device(s) 104a are configured to emit light to illuminate portions of a ground path.

As an example, the interior lighting device(s) 104b include interior lighting devices within a flight deck or cockpit of the aircraft 102. Such interior lighting devices are configured to illuminate a surface inside of the aircraft 102. For example, the interior lighting device(s) 104b are configured to emit light to illuminate a portion of a window (such as a windshield) of the flight deck or cockpit. In this manner, the interior lighting device(s) 104b can be configured to emit light to provide a heads-up display on the window of the flight deck or cockpit.

In at least one example, the lighting device(s) 104 include light emitting diode(s) configured to emit different colors of light, illuminated messages (such as text and/or graphics), and/or the like. As another example, the lighting device(s) 104 include one or more light emitters (such as incandescent or fluorescent lighting elements), a projector, a slide reel in front of the light emitter(s), a motor coupled to the slide reel, and/or the like, which are configured to cooperate to emit different colors of light, illuminated messages (such as text and/or graphics), and/or the like.

The system 100 includes a control unit 106 in communication with the lighting device(s) 104, such as through one or more wired or wireless connections. The control unit 106 is configured to control operation of the lighting device(s) 104 to emit light to provide traffic information on one or more surfaces. The control unit 106 can be dedicated to operation of the lighting device(s) 104. For example, a lighting device 104 can include the control unit 106. As another example, the control unit 106 can be part of a flight computer of the aircraft 102. Optionally, the control unit 106 can be remote from the aircraft 102, such as at a central monitoring location.

In at least one example, the control unit 106 is coupled to a communication device 108, such as one or more of an antenna, a transceiver, an internet connection, a cloud-based connection, and/or the like. The control unit 106 is in communication with one or more of a tracking sub-system 110, an airport database 112, and/or air traffic control 114 through the communication device 108.

The tracking sub-system 110 is configured to track the aircraft 102, other aircraft, ground vehicles, and/or the like. In at least one example, the tracking sub-system 110 is configured to track positions of the aircraft 102, the other aircraft, ground vehicles, and the like in real time. In at least one example, the tracking sub-system 110 is a radar sub-system. As another example, the tracking sub-system 110 is an automatic dependent surveillance-broadcast (ADS-B) tracking sub-system. Real time positions of the aircraft 102 on the ground and within an airspace are detected by the tracking sub-system 110, which receives position signals output by a position sensor of the aircraft 102. For example, the tracking sub-system 110 receives ADS-B signals output by the position sensors of the aircraft 102. As another example, the position sensor of the aircraft 102 can be one or more global positioning system sensors. The position sensor outputs signals indicative of one or more of the position, altitude, heading, acceleration, velocity, and/or the like of the aircraft 102.

The airport database 112 includes one or more electronic maps of an airport. The maps include the ground paths of the airport, including intersections between ground paths, which may include hot spots. In at least one example, the control unit 106 receives tracking information (including positions of the aircraft 102, other aircraft, ground vehicles, and/or the like) from the tracking sub-system 110, and locates the tracking information on one or more maps within map information received from the airport database 112. Optionally, the tracking information provided from the tracking sub-system 110 also includes the map information.

In operation, the control unit 106 operates the lighting device(s) 104 to provide traffic information on one or more surfaces in response to tracked positions of the aircraft 102 and other aircraft at an airport (such as from information received from one or more of the tracking sub-system 110, the airport database 112, and/or air traffic control 114). For example, the control unit 106 determines a position of the aircraft 102 at an airport in relation to one or more ground paths from the tracking information received from the tracking sub-system 110, map information received from the airport database 112, and/or clearance information received from the air traffic control 114. In response to such information, the control unit 106 operates the exterior lighting device(s) 104a to provide an illuminated message on an exterior surface (that is, a surface outside of the aircraft 102), such as a ground path on which the aircraft 102 is supported. As another example, the control unit 106 operates the interior lighting device(s) 104b to provide an illuminated message on an interior surface (that is, a surface inside of the aircraft 102), such as an interior surface of a window within a flight deck of cockpit of the aircraft. As another example, the control unit 106 operates both the exterior lighting device(s) 104(a) and the interior lighting device(s) 104b to provide the illuminated message on the exterior surface and the interior surface, respectively.

In at least one example, the control unit 106 operates the lighting device(s) in response to detecting that the aircraft 102 is proximate to an intersection between two ground paths. For example, the intersection is a hot spot. As an example, the control unit 106 receives the tracking information from the tracking sub-system 110 to determine a location of the aircraft 102 in relation to the intersection. In response to determining that the aircraft 102 is within a predetermined distance from the intersection (such as within 100 yards), the control unit 106 automatically activates the lighting device(s) 104 to emit the illuminated message regarding traffic at the intersection. Optionally, the predetermined distance can be greater than 100 yards, such as 200 yards, or less than 100 yards, such as 50 yards. As another example, the control unit 106 can operate the lighting device(s) 104 to illuminate messages regarding traffic at all times when the aircraft 102 is on a ground path at the airport.

The lighting device(s) 104 are operated to emit light to provide illuminated messages regarding traffic in relation to the ground path(s). The illuminated messages can include one or more of symbols, shapes, different colors, text, and/or graphics. The lighting device(s) 104 provide traffic information via the illuminated messages on an exterior surface (such as a portion of a ground path on which the aircraft 102 travels), and/or an interior surface (such as on a window within the flight deck or cockpit) to ensure that an operator of the aircraft 102 is able to view the traffic information while maintaining situational awareness of the aircraft (for example, without looking down at a map or display).

In at least one example, the control unit 106 receives information regarding one or more hot spots at an airport, such as via map information received from the airport database 112, position information of the aircraft 102, and traffic information (regarding other aircraft, for example) from the tracking sub-system 110, and clearance information from air traffic control 114. The control unit 106 operates the lighting device(s) 104 based on such information.

As described herein, the system 100 includes the aircraft 102 including one or more lighting devices 104. The control unit 106 is in communication with the one or more lighting devices 104. The control unit 106 is configured to operate the one or more lighting devices 104 to provide illuminated messages regarding traffic in relation to one or more ground paths at an airport on one or more surfaces. In at least one example, the one or more lighting devices 104 include one or more exterior lighting devices 104a, and the one or more surfaces include a portion of the one or more ground paths ahead of the aircraft 102. In at least one other example, the one or more lighting devices 104 include one or more interior lighting devices 104b, and the one or more surfaces include an interior portion of a window within a flight deck or cockpit of the aircraft 102. In at least one other example, the one or more lighting devices 104 include the one or more exterior lighting devices 104a, and the one or more interior lighting devices 104b.

FIG. 2 illustrates a flow chart of a method, according to an example of the present disclosure. Referring to FIGS. 1 and 2, at 200, the tracking sub-system 110 tracks a position of the aircraft 102 (and other aircraft) at an airport. The tracking sub-system 110 outputs traffic information regarding ground paths of the airport. The traffic information includes real time positions of the aircraft and other aircraft in relation to the ground paths. At 202, the control unit 106 receives the traffic information for the ground paths of the airport from the tracking sub-system 110. At 204, the control unit 106 operates one or more lighting devices 104 of the aircraft 102 to provide illuminated messages regarding the traffic on one or more surfaces (such as exterior surfaces outside of the aircraft 102 and/or interior surfaces within the aircraft 102). The illuminated messages include one or more of text, shapes, graphics, and/or colors that provide readily discernable information (such as information standardized by a regulatory agency, such as the FAA) regarding the traffic in relation to the ground path(s) to an operator of the aircraft 102.

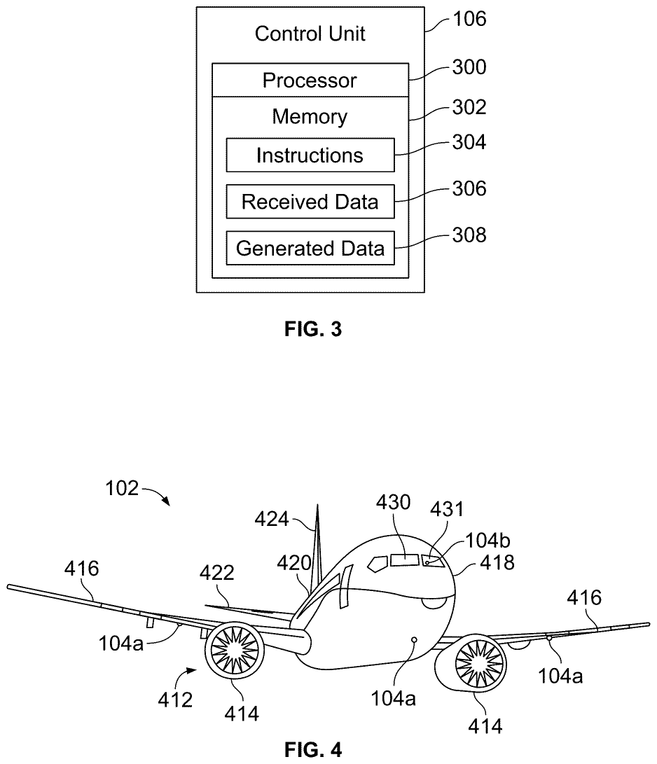

FIG. 3 illustrates a schematic block diagram of the control unit 106, according to an example of the present disclosure. In at least one example, the control unit 106 includes at least one processor 300 in communication with a memory 302. The memory 302 stores instructions 304, received data 306, and generated data 308. The control unit 106 shown in FIG. 3 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 106 may be or include one or more processors that are configured to control operation, as described herein.

The control unit 106 is configured to execute a set of instructions that are stored in one or more data storage units or elements (such as one or more memories), in order to process data. For example, the control unit 106 may include or be coupled to one or more memories. The data storage units may also store data or other information as desired or needed. The data storage units may be in the form of an information source or a physical memory element within a processing machine.

The set of instructions may include various commands that instruct the control unit 106 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 106. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 106 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 4 illustrates a perspective front view of an aircraft 102, according to an example of the present disclosure. The aircraft 102 includes a propulsion system 412 that includes engines 414, for example. Optionally, the propulsion system 412 may include more engines 414 than shown. The engines 414 are carried by wings 416 of the aircraft 102. In other examples, the engines 414 may be carried by a fuselage 418 and/or an empennage 420. The empennage 420 may also support horizontal stabilizers 422 and a vertical stabilizer 424. The fuselage 418 of the aircraft 102 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like.

The aircraft 102 includes exterior lighting devices 104a, such as landing lights, disposed on the wings 416 and/or the fuselage 418, and interior lighting devices 104b, such as within the internal cabin 430 (for example, within the flight deck or cockpit). The exterior lighting devices 104a are configured to provide illuminated messages regarding traffic on a ground path. The interior lighting devices 104b are configured to provide illuminated messages regarding traffic on an interior surface of a window 431, such as a windshield of the flight deck or cockpit. The aircraft 102 can include more or fewer exterior lighting devices 104a or interior lighting devices 104b than shown. In at least one example, the aircraft 102 includes the exterior lighting device(s) 104a, but not the interior lighting device(s) 104b. In at least one other example, the aircraft 102 includes the interior lighting device(s) 104b, but not the exterior lighting device(s) 104b.

FIG. 4 shows an example of an aircraft 102. It is to be understood that the aircraft 102 can be sized, shaped, and configured differently than shown in FIG. 4.

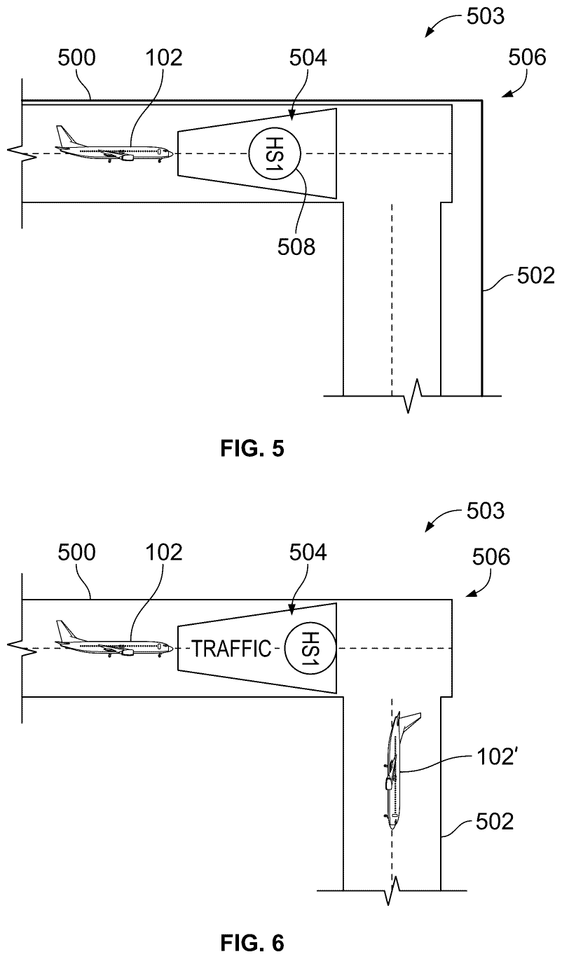

FIG. 5 illustrates a simplified diagram of the aircraft 102 on a first ground path 500 that intersects a second ground path 502 at an airport 503, according to an example of the present disclosure. The first ground path 500 can be a taxiway, while the second ground path 502 can be another taxiway. As another example, the first ground path 500 can be a taxiway, while the second ground path 502 can be a runway.

Referring to FIGS. 1 and 5, the aircraft 102 includes one or more exterior lighting devices 104a (such as landing lights), which are operated by the control unit 106 to provide an illuminated message 504 on the ground path 500 in front of the aircraft 102. The illuminated message 504 includes information the traffic in relation to the first ground path 500 and the second ground path 502 (such as the intersection therebetween).

In this example, map information received from the airport database 112 indicates that the intersection of the first ground path 500 and the second ground path 502 is a hot spot 506. The control unit 106 determines, from the tracking information received from the tracking sub-system 110 and the map information received from the airport database 112, that the aircraft 102 is approaching the hot spot 506, and that there is no surrounding traffic. As such, the control unit 106 operates the exterior lighting device(s) 104a to project the illuminated message 504 onto the first ground path 500 in front of the aircraft 102 to include information regarding the hot spot 506 (such as readily discernable text indicating the hot spot, for example, HS1) enclosed in a shape, such as a circle 508, which is a readily discernable indicator of a ground movement hot spot. The illuminated message 504 can further be shown in one or more colors (such as black or green) to denote no traffic or adverse events detected near the hot spot 506.

The control unit 106 can control interior lighting device(s) 104b to provide the illuminated message 504 onto an interior surface (such as of a window of the aircraft 102) in a similar manner.

FIG. 6 illustrates a simplified diagram of the aircraft 102 on the first ground path 500 that intersects the second ground path 502 at the airport 503, according to an example of the present disclosure. As shown, the aircraft 102 is approaching the hot spot 506 in which another aircraft 102′ is on the ground path 502. As such, the control unit 106 operates the exterior lighting device(s) 104a to provide the illuminated message 504 on the ground path 500 in front of the aircraft 102 to include text, such as TRAFFIC, the circle 508, and the text and/or circle can be shown in a different color indicating an alert. For example, the different color can be red.

The control unit 106 can control interior lighting device(s) 104b to provide the illuminated message 504 onto an interior surface (such as of a window of the aircraft 102) in a similar manner.

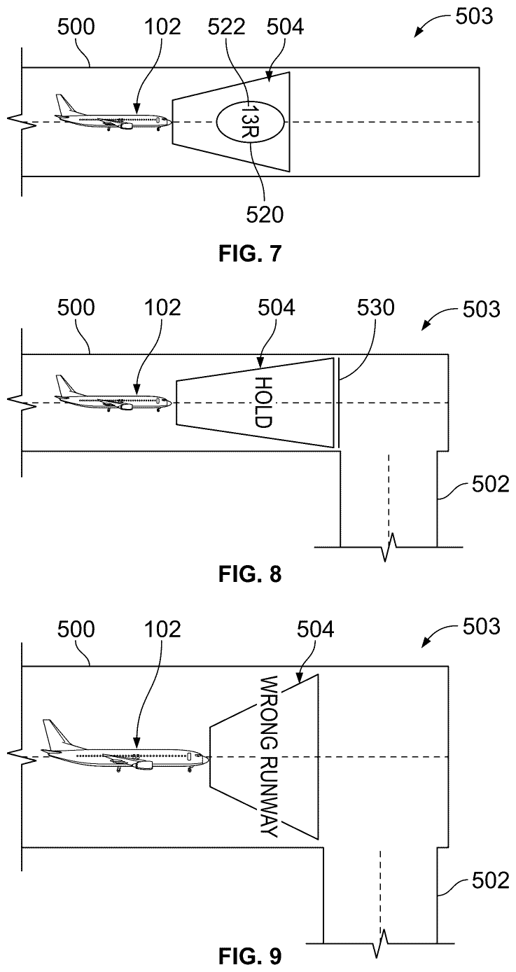

FIG. 7 illustrates a simplified diagram of the aircraft 102 on the first ground path 500, according to an example of the present disclosure. Referring to FIGS. 1 and 7, in this example, the aircraft 102 is approaching a wrong surface. Accordingly, the control unit 106 operates the exterior lighting device(s) 104a to provide the illuminated message 504 on the ground path 500 ahead of the aircraft 102, such that the illuminated message 504 includes an ellipse 520 (indicating a wrong surface), and optionally an alert message 522.

The control unit 106 can control interior lighting device(s) 104b to provide the illuminated message 504 onto an interior surface (such as of a window of the aircraft 102) in a similar manner.

FIG. 8 illustrates a simplified diagram of the aircraft 102 on the first ground path 500 that intersects the second ground path 502 at the airport 503, according to an example of the present disclosure. Referring to FIGS. 1 and 8, in this example, the aircraft 102 is approaching hold lines 530 on the ground path 500. As such, the control unit 106 operates the exterior lighting device(s) 104a to provide the illuminated message 504 on the ground path ahead of the aircraft 102, such that the illuminated message 504 includes text showing HOLD.

The control unit 106 can control interior lighting device(s) 104b to provide the illuminated message 504 onto an interior surface (such as of a window of the aircraft 102) in a similar manner.

FIG. 9 illustrates a simplified diagram of the aircraft 102 on the first ground path 500 that intersects the second ground path 502 at the airport 503, according to an example of the present disclosure. Referring to FIGS. 1 and 9, in this example, information received from air traffic control 114 indicates to the control unit 106 that the aircraft 102 is approaching an incorrect runway or otherwise a runway that the aircraft 102 has not been granted clearance. Accordingly, the control unit 106 operates the exterior lighting device(s) 104a to provide the illuminated message 504 on the ground path ahead of the aircraft 102, such that the illuminated message 504 includes text showing WRONG RUNWAY.

The control unit 106 can control interior lighting device(s) 104b to provide the illuminated message 504 onto an interior surface (such as of a window of the aircraft 102) in a similar manner.

FIGS. 5-9 show examples of the illuminated messages 504 regarding traffic at the airport 503. It is to be understood that such are merely examples, and the control unit 106 can operate the lighting device(s) 104 to show various other kinds of information, in various other ways, and/or with other types of indicia.

Further, the disclosure comprises examples according to the following clauses:
Clause 1. A system comprising:
an aircraft including one or more lighting devices; and
a control unit in communication with the one or more lighting devices, wherein the control unit is configured to operate the one or more lighting devices to provide illuminated messages regarding traffic in relation to one or more ground paths at an airport on one or more surfaces.
Clause 2. The system of Clause 1, wherein the aircraft comprises the control unit.
Clause 3. The system of Clauses 1 or 2, wherein the one or more lighting devices comprise one or more exterior lighting devices, and wherein the one or more surfaces comprise a portion of the one or more ground paths ahead of the aircraft.
Clause 4. The system of Clause 3, wherein the one or more exterior lighting devices include one or more landing lights secured to one or more wings or a fuselage of the aircraft.
Clause 5. The system of Clause 1, wherein the one or more lighting devices comprise one or more interior lighting devices, and wherein the one or more surfaces comprise an interior portion of a window within a flight deck or cockpit of the aircraft.
Clause 6. The system of Clause 1, wherein the one or more lighting devices comprise:
one or more exterior lighting devices, and wherein the one or more surfaces comprise a portion of the one or more ground paths ahead of the aircraft; and
one or more interior lighting devices, and wherein the one or more surfaces further comprise an interior portion of a window within a flight deck or cockpit of the aircraft.
Clause 7. The system of any of Clauses 1-6, wherein the control unit is configured to operate the one or more lighting devices responsive to one or more of tracking information received from a tracking sub-system, map information received from an airport database, or clearance information received from air traffic control.
Clause 8. The system of Clause 7, wherein the control unit is configured to operate the one or more lighting devices responsive to the tracking information received from the tracking sub-system, the map information received from the airport database, and the clearance information received from the air traffic control.
Clause 9. The system of any of Clauses 1-8, wherein the illuminated messages comprise one or more of symbols, shapes, colors, text, or graphics.
Clause 10. The system of Clause 9, wherein the illuminated messages comprise shapes colors, and text.
Clause 11. The system of any of Clauses 1-10, wherein the illuminated messages comprise readily discernable text and a readily discernable shape for a hot spot.
Clause 12. A method for a system comprising:
an aircraft including one or more lighting devices; and
a control unit in communication with the one or more lighting devices, wherein the control unit is configured to operate the one or more lighting devices to provide illuminated messages regarding traffic in relation to one or more ground paths at an airport on one or more surfaces,
the method comprising:
operating, by the control unit, the one or more lighting devices to provide the illuminated messages regarding the traffic in relation to the one or more ground paths at the airport on the one or more surfaces.
Clause 13. The method of Clause 12, wherein the one or more lighting devices comprise one or more exterior lighting devices, and wherein the one or more surfaces comprise a portion of the one or more ground paths ahead of the aircraft.
Clause 14. The method of Clauses 12 or 13, wherein the one or more lighting devices comprise one or more interior lighting devices, and wherein the one or more surfaces comprise an interior portion of a window within a flight deck or cockpit of the aircraft.
Clause 15. The method of any of Clauses 12-14, wherein said operating is responsive to one or more of tracking information received from a tracking sub-system, map information received from an airport database, or clearance information received from air traffic control.
Clause 16. The method of any of Clauses 12-15, wherein the illuminated messages comprise one or more of symbols, shapes, colors, text, or graphics.
Clause 17. The method of Clause 16, wherein the illuminated messages comprise shapes colors, and text.
Clause 18. The method of any of Clauses 12-17, wherein the illuminated messages comprise readily discernable text and a readily discernable shape for a hot spot.
Clause 19. An aircraft comprising:
one or more lighting devices; and
a control unit in communication with the one or more lighting devices, wherein the control unit is configured to operate the one or more lighting devices to provide illuminated messages regarding traffic in relation to one or more ground paths at an airport on one or more surfaces, wherein the illuminated messages comprise shapes colors, and text, and wherein the control unit is configured to operate the one or more lighting devices responsive to tracking information received from a tracking sub-system, map information received from an airport database, and clearance information received from air traffic control.
Clause 20. The aircraft of Clause 19, wherein the one or more lighting devices comprise one or both of:
one or more exterior lighting devices, and wherein the one or more surfaces comprise a portion of the one or more ground paths ahead of the aircraft; or
one or more interior lighting devices, and wherein the one or more surfaces comprise an interior portion of a window within a flight deck or cockpit of the aircraft.

As described herein, examples of the present disclosure provide systems and method for efficiently and effectively informing an operator of an aircraft of traffic information at an airport, such as at hot spots. Further, examples of the present disclosure provide systems and methods for providing traffic information to one or more operators of aircraft while ensuring that the operator(s) maintains situational awareness of a location of the aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an aircraft including one or more lighting devices; and
a control unit in communication with the one or more lighting devices, wherein the control unit is configured to operate the one or more lighting devices to provide illuminated messages regarding traffic in relation to one or more ground paths at an airport on one or more surfaces.

2. The system of claim 1, wherein the aircraft comprises the control unit.

3. The system of claim 1, wherein the one or more lighting devices comprise one or more exterior lighting devices, and wherein the one or more surfaces comprise a portion of the one or more ground paths ahead of the aircraft.

4. The system of claim 3, wherein the one or more exterior lighting devices include one or more landing lights secured to one or more wings or a fuselage of the aircraft.

5. The system of claim 1, wherein the one or more lighting devices comprise one or more interior lighting devices, and wherein the one or more surfaces comprise an interior portion of a window within a flight deck or cockpit of the aircraft.

6. The system of claim 1, wherein the one or more lighting devices comprise:
one or more exterior lighting devices, and wherein the one or more surfaces comprise a portion of the one or more ground paths ahead of the aircraft; and
one or more interior lighting devices, and wherein the one or more surfaces further comprise an interior portion of a window within a flight deck or cockpit of the aircraft.

7. The system of claim 1, wherein the control unit is configured to operate the one or more lighting devices responsive to one or more of tracking information received from a tracking sub-system, map information received from an airport database, or clearance information received from air traffic control.

8. The system of claim 7, wherein the control unit is configured to operate the one or more lighting devices responsive to the tracking information received from the tracking sub-system, the map information received from the airport database, and the clearance information received from the air traffic control.

9. The system of claim 1, wherein the illuminated messages comprise one or more of symbols, shapes, colors, text, or graphics.

10. The system of claim 9, wherein the illuminated messages comprise shapes colors, and text.

11. The system of claim 1, wherein the illuminated messages comprise readily discernable text and a readily discernable shape for a hot spot.

12. A method for a system comprising:
an aircraft including one or more lighting devices; and
a control unit in communication with the one or more lighting devices, wherein the control unit is configured to operate the one or more lighting devices to provide illuminated messages regarding traffic in relation to one or more ground paths at an airport on one or more surfaces,
the method comprising:
operating, by the control unit, the one or more lighting devices to provide the illuminated messages regarding the traffic in relation to the one or more ground paths at the airport on the one or more surfaces.

13. The method of claim 12, wherein the one or more lighting devices comprise one or more exterior lighting devices, and wherein the one or more surfaces comprise a portion of the one or more ground paths ahead of the aircraft.

14. The method of claim 12, wherein the one or more lighting devices comprise one or more interior lighting devices, and wherein the one or more surfaces comprise an interior portion of a window within a flight deck or cockpit of the aircraft.

15. The method of claim 12, wherein said operating is responsive to one or more of tracking information received from a tracking sub-system, map information received from an airport database, or clearance information received from air traffic control.

16. The method of claim 12, wherein the illuminated messages comprise one or more of symbols, shapes, colors, text, or graphics.

17. The method of claim 16, wherein the illuminated messages comprise shapes colors, and text.

18. The method of claim 12, wherein the illuminated messages comprise readily discernable text and a readily discernable shape for a hot spot.

19. An aircraft comprising:
one or more lighting devices; and
a control unit in communication with the one or more lighting devices, wherein the control unit is configured to operate the one or more lighting devices to provide illuminated messages regarding traffic in relation to one or more ground paths at an airport on one or more surfaces, wherein the illuminated messages comprise shapes colors, and text, and wherein the control unit is configured to operate the one or more lighting devices responsive to tracking information received from a tracking sub-system, map information received from an airport database, and clearance information received from air traffic control.

20. The aircraft of claim 19, wherein the one or more lighting devices comprise one or both of:
one or more exterior lighting devices, and wherein the one or more surfaces comprise a portion of the one or more ground paths ahead of the aircraft; or
one or more interior lighting devices, and wherein the one or more surfaces further comprise an interior portion of a window within a flight deck or cockpit of the aircraft.
